(19) United States
(12) Patent Application Publication
(10) Pub. No.: US 2015/0178572 A1
(43) Pub. Date: Jun. 25, 2015

(54) ROAD SURFACE CONDITION CLASSIFICATION METHOD AND SYSTEM

(71) Applicants: Raqib OMER, (US); Liping FU, (US)

(72) Inventors: Raqib Omer, Waterloo (CA); Liping Fu, Waterloo (CA)

(21) Appl. No.: 14/403,505

(22) PCT Filed: May 23, 2013
(86) PCT No.: PCT/CA2013/000504

§ 371 Date: Nov. 24, 2014

Related U.S. Application Data
(60) Provisional application No. 61/650,804, filed on May 23, 2012.

(51) Int. Cl. G06K 9/00; G06K 9/66; G06K 9/62

(52) U.S. Cl. CPC G06K 9/00791; G06K 9/6267; G06K 9/66

(57) ABSTRACT

There is disclosed a method and system for classifying road surface conditions. In an aspect, the method comprises: acquiring a digital image of a road surface at a given location and time; processing the acquired digital image to generate one or more feature vectors for classifying winter road surface conditions; acquiring values for auxiliary data to create feature vectors that enhance classification of the winter road surface conditions; and based on a comparison of the feature vectors to models in a classification knowledge database, classifying the road surface condition at the given location and time of the acquired digital image. In an embodiment, the method further comprises collecting classified road surface condition information acquired from a plurality of vehicles travelling over one or more roads; and mapping the classified winter road surface conditions for the one or more roads on a graphical display of a geographic region.

### FIELD

The present disclosure relates to a method and system for classifying road surface conditions for winter road maintenance optimization and commuter safety.

### BACKGROUND

Accurately determining road surface conditions is necessary for various road maintenance applications, including proper allocation and utilization of available road maintenance resources and road surface treatment materials before, during and after winter weather events. For example, during winter, road maintenance may involve removal of snow and treatment of icy road conditions with a combination of salt, sand and other road surface treatment materials utilizing snow plows and salt/sand spreader vehicles.

One prior art method of determining the surface condition of roads includes contactless road condition monitoring relying on purpose built optical or ultrasonic sensor devices that measure the reflection and/or backscatter of an impinged optical signal to determine the prevailing road surface condition. However, the data provided by this type of detection is generally useful only to the particular vehicle on which the sensor is mounted.

Another known method involves employing a friction measuring wheel mounted to a vehicle to measure the relative slippage between the friction measuring wheel and a road surface to determine the surface conditions. However, the ability to accurately assess the overall road surface conditions may be limited as the measuring wheel only travels along a narrow line following the wheel-track of the vehicle representing only a very small fraction of the road surface.

As another example, U.S. Pat. No. 6,807,473 discloses an apparatus and method for detecting the road condition for use in a motor vehicle. The system and method detect road data through a temperature sensor, an ultrasonic sensor, and a camera. Road data is filtered and a comparison of the filtered road data is made to reference data. A confidence level of that comparison is generated, and based on the comparison of filtered road data to reference data, and an overall road condition is determined.

However, all of the above-mentioned technologies measure road surface conditions over a relatively small footprint or in the immediate vicinity of a vehicle. Moreover, the technologies are not capable of determining road surface conditions along the width of a single or multiple lanes and also do not provide the nature of the contaminant/snow. For illustration, the example of a center covered wheel track bare road can be considered, in which case the road coverage cannot be determined by a single condition. Another example of a road covered with snow in one case and slush in another case is considered where the two contaminants are of a different type and may require different maintenance treatments or safety precautions. What is needed is a solution for providing an accurate determination of road surface conditions for winter maintenance optimization and commuter safety over a broader geographic area.

### SUMMARY

The present disclosure relates to a road surface condition classification method, system and apparatus for classifying road surface conditions, more specifically for winter road maintenance optimization and commuter safety.

In an aspect, there is provided a computer implemented method for classifying winter road surface conditions, comprising: acquiring a digital image of a road surface at a given location and time; processing the acquired digital image to generate one or more feature vectors for classifying winter road surface conditions; acquiring values for auxiliary data to create feature vectors that enhance classification of the winter road surface conditions; and based on a comparison of the feature vectors to models in a classification knowledge database, classifying the road surface condition at the given location and time of the acquired digital image.

In an embodiment, the method further comprises: collecting classified road surface condition information acquired from a plurality of vehicles travelling over one or more roads; and mapping the classified winter road surface conditions for the one or more roads on a graphical display of a geographic region.

In another aspect, there is provided a system for classifying winter road surface conditions, wherein the system is adapted to: acquire a digital image of a road surface at a given location and time; process the acquired digital image to generate one or more feature vectors for classifying winter road surface conditions; acquire values for auxiliary data to create feature vectors that enhance classification of the winter road surface conditions; and classify the road surface condition at the given location and time of the acquired digital image based on a comparison of the feature vectors to models in a classification knowledge database.

In an embodiment, the system is further adapted to: collect classified road surface condition information acquired from a plurality of vehicles travelling over one or more roads; and map the classified winter road surface conditions for the one or more roads on a graphical display of a geographic region.

In an embodiment, the data collection module may record vehicle location data obtained from a GPS together with vehicle engine information obtained from the vehicle's engine control unit (ECU) to store additional information about various vehicle parameters at a stretch of road over which the vehicle was traveling at the time when the digital image was captured. The data obtained from the ECU may include, for example, vehicle speed, acceleration, deceleration, and engagement of the anti-lock braking system (ABS). The data collection module may also record data from various on-vehicle sensors including temperature sensors and various other environmental or motion sensors mounted on the vehicle in addition to the image capture device.

In another embodiment, a classification knowledge database of classified road conditions, pavement characteristics, geographic, weather and environmental data, road maintenance data, GPS and associated data is maintained and compared against the measured data to predict road surface conditions based on recorded image data. The prediction may be confirmed based on feedback of actual road surface conditions by personnel in the field. Thus, over time, predictions based on the collected data may be improved such that the method and can more accurately determine the actual road surface conditions based on the recorded digital images and associated data of the road surfaces and the measured data.

In an embodiment, the method and system includes a classification engine which uses the classification knowledge database and a plurality data processing, machine vision and artificial intelligence algorithms on road condition data collected from a single or plurality of data collection modules mounted on a plurality of vehicles. The classification engine analyzes the captured digital image of the road surfaces and the data collected from other environmental sensor to classify the most likely road condition based on the collected and processed data.

In an embodiment, the method and system includes a server which collects road surface condition data from a plurality of data collection modules mounted on a plurality of vehicles traveling over roads in a given geographic area of interest (e.g. in a given municipality). The server accumulates and processes data collected from the data collection modules mounted on a plurality of vehicles in order to have the most recent road surface condition data available for making winter road maintenance decisions. A simple web interface provides users with an up-to-date view of road surface conditions based on the classified road conditions.

In this respect, before explaining at least one embodiment of the system and method of the present disclosure in detail, it is to be understood that the present system and method is not limited in its application to the details of construction and to the arrangements of the components set forth in the following description or illustrated in the drawings. The present system and method is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is an illustrative screen shot of a web interface in accordance with an embodiment.

FIG. 2 is an illustrative schematic block diagram of a system in accordance with an embodiment.

FIG. 3A is an illustrative schematic block diagram of a road surface condition classification engine and related components in accordance with an embodiment.

FIG. 3B is an illustrative schematic block diagram of a data collection module in accordance with an embodiment.

FIG. 3C is an illustrative schematic flow chart of road surface condition classification carried out on acquired road images.

FIG. 4 is an illustrative schematic block diagram of a classification model in accordance with an exemplary embodiment.

FIGS. 5A-5C are illustrative schematic flow charts of various image processing methods in accordance with exemplary embodiments.

FIG. 6 illustrates the overall real-time image classification process based on trained models.

FIG. 7 illustrates a generic computer system which may provide a suitable operating environment for various embodiments.

### DETAILED DESCRIPTION OF THE PREFERRED EMBODIMENT

As noted above, the present disclosure relates to a road surface condition classification method and system for classifying road surface conditions for winter road maintenance optimization and commuter safety.

An objective of the present method and system is the optimization of winter road maintenance and commuter safety in a given geographic region, such as a municipality, which requires an up-to-date assessment of the latest road conditions on a wide scale and at a finer resolution than was previously available for winter road conditions. For example, simply determining the presence of snow on a particular road may not be sufficient for determining the proper road maintenance procedure to be applied. Rather, what is required is to be able to determine a wide range of road surface conditions on various roads in a given geographic area, based on the amount and coverage pattern of one or more of snow, ice and slush. For example, the classifications may include: snow covered, loose snow, packed snow, bonded snow, drifting snow, center covered with snow and track bare, ice covered, slush covered, center covered with slush and track bare, bare wet, bare dry, and fully bare, etc., which may exist on different roads and different lanes of a road at the same time. Some of the variables that control these conditions are traffic flow, and recent road maintenance utilizing plowing and spreading of materials.

In the present disclosure, “road surface condition” refers to the condition of the road in terms of contaminants and their coverage. Contaminants include loose snow, drifting snow, ice, slush, packed snow etc, whereas coverage may also include a range, such as fully covered, center covered track bare, one track bare, patches, etc. This condition may also vary across different lanes of a road, and thus the system should be able to identify the lateral coverage across a single lane or across multiple lanes.

In an embodiment, the method and system acquires digital pavement images using an onboard data acquisition system. The method and system also collects supplemental data, such as vehicular data and environmental data, that help to validate a road condition classification based on image processing. As an illustrative example, weather forecast information may be collected from a local weather office which provides an up-to-date information on current weather as well as historic weather information. The environmental conditions may include, for example, ambient air temperature, pavement temperature, amount and type of precipitation in previous hours, current and recent wind speed, amount of cloud cover, and so on. The method and system may also acquire up-to-date information on recent road maintenance activities, including snow removal and salting/sanding performed within a specified time period. Furthermore, the method and system may also require location specific information of the acquired images based on GPS coordinates. This information may include information such as the presence of a snow fence or trees alongside the road as well as general topography information which may be previously available from existing maintenance, weather and asset management systems.

In an embodiment, a classification engine analyzes the digital images together with the supplemental data to classify and validate the road surface conditions based on analysis of the digital images and corresponding values for various parameters acquired from the supplemental data. The classification engine may rely on an existing set of pre-classified road condition images, environmental, vehicular, and topographical and other data. For example, while preparing an existing classified dataset for use in classification, an individual may manually observe numerous sets of images and corresponding vehicular and weather conditions associated to those images. When the system then acquires an image together with supplemental data, an image class may then be selected to label the image as well as associated data with a road surface condition.

In an embodiment, a data collection module is adapted to be installable on a vehicle, or a stationary location such as a light pole, to capture digital images of the road surface using a digital camera. In this context, a digital camera may refer to a specialized camera purpose built for machine vision or a regular camera used for photography or a computer camera or a surveillance camera, or an onboard camera available on smart phones or tablets, for example. The digital camera is connected to a data collection module to store the captured data. The data collection module may then employ a purpose built computer system adapted to execute software code written to store the captured digital images along with other data collected from various sources.

In another embodiment, the data collection module may record vehicle location data obtained from a GPS together with vehicle engine information (if available) obtained from the vehicle's engine control unit (ECU) to store additional information about a stretch of road over which the vehicle was traveling at the time when the digital image was captured. The data obtained from the ECU may include, for example, vehicle speed, acceleration, deceleration, and engagement of the anti-lock braking system (ABS) or traction control system (TCS). The data collection module may also record data from various on-vehicle sensors including temperature sensors and various other environmental or motion sensors mounted on the vehicle in addition to the image capture device.

In another embodiment, one or more classification knowledge databases may be maintained to store classified road conditions together with the measured data for different topographies, pavement color, location, and conditions. The predicted road surface classification may be confirmed based on feedback of actual road surface conditions as verified in the field. Thus, over time, predictions based on the captured data may be improved such that the method and system can more accurately determine the actual road surface conditions based on the recorded digital images of the road surfaces and the measured data.

In an embodiment, the method and system includes a central server which exchanges data with a plurality of data collection modules mounted on a plurality of vehicles traveling over roads in a given geographic area of interest (e.g. in a given municipality). The central server may hold previously entered topological information like type of road, existence of snow fences or trees, number of lanes, GPS coordinates etc, and be able to track the location of a plurality of vehicles travelling in a given area at any given time.

The central server may also hold maintenance information for given road segments for example the type of maintenance (salting, sanding, plowing etc) and the time of maintenance and other related maintenance information.

The central server may also store relevant weather information for given road segments like type and amount of precipitation, air and pavement temperature, cloud cover and other information.

The central server may further store road surface condition classification models that may or may not be specific to particular road segments or areas. As an example, at least a part of the pre-classified data set that is used to train a specific classification model may come from a specific location (road, area region). This classification model may also be downloaded to a computing device provided on a vehicle or on an operatively connected mobile device such as a smart phone or tablet, thereby allowing road surface classification to occur on the vehicle prior to the data being uploaded to the central server.

Upon request, the central server may transmit to a data collection unit, all or part of the above mentioned data for a specific location. This information may be used by the mobile units to classify the most likely road condition based on the recorded data and by using an existing classification model that may be generic or more specific to a road, area or a region.

A simple web interface provides users with an up-to-date view of road surface conditions based on the collected data of classified road conditions from multiple vehicles on the road over a given period of time. This collected information may then be used to initiate road maintenance procedures which are targeted to the actual conditions on the roads, rather than making assumptions of road conditions in an entire geographic region. The data may also be used to advise commuters of near real-time road surface conditions. Live and previously archived data may be used to assess performance of maintenance operations including but not limited to performance of materials, maintenance procedure tactics, equipment and the general performance of the maintenance department or contactor.

The method and system will now be described in more detail with reference to the figures.

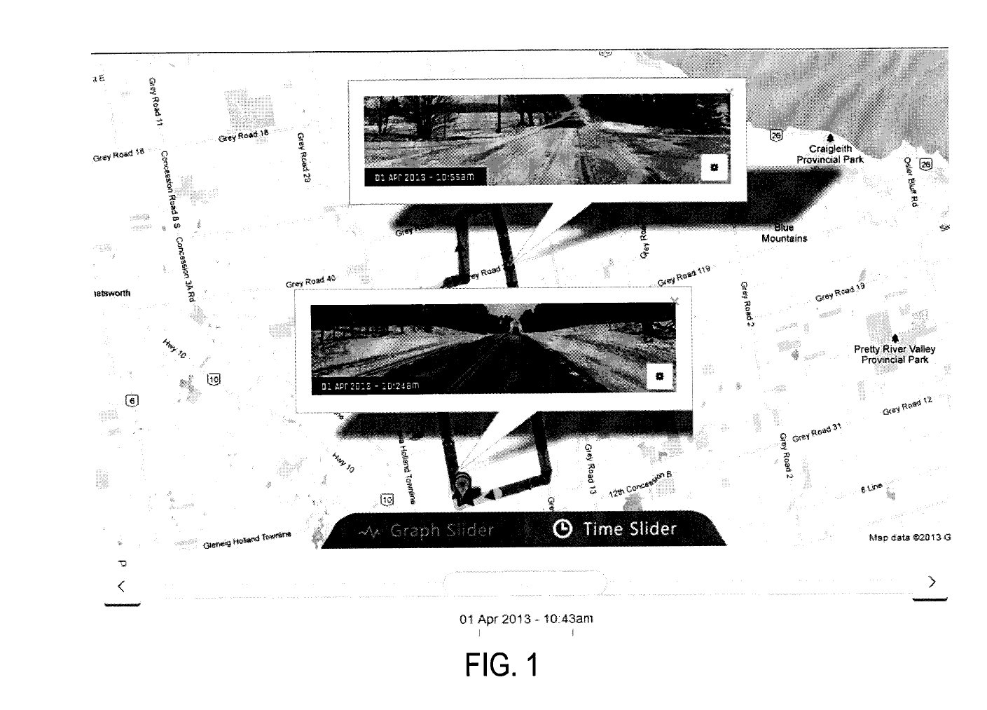

FIG. 1 is an illustrative screen shot of a web interface in accordance with an embodiment. As shown, a map of a geographic area of interest is displayed together with a highlighted route over various roads taken by a vehicle in the geographic area. At two arbitrary points (selected by the user using a graphical user interface input device, for example a mouse) along the highlighted route, pop-up windows show a frame of a captured digital image of the road as captured by the system. The inferred road surface conditions along the route may be represented by color coded line drawn along the roads where road condition data is available. As described earlier, the digital image of the road surfaces may be captured by a camera mounted to a vehicle which traveled the highlighted route, and recorded by a data collection module. In addition to the captured digital image, the data collection module collects other data including location information and vehicle data from the ECU (including speed, engagement of the ABS etc.). Additional data may be obtained from road maintenance activities undertaken by maintenance equipment including, but not limited to, snow plows, salt and sand spreaders, etc.).

In an embodiment, the web interface may provide real-time information on road surface conditions that may alert commuters and road maintenance staff to road surface conditions on various roads within a given geographical area. This information may be used by commuters to avoid roads with particularly hazardous conditions, and for road maintenance staff to prioritize snow plowing and road surface treatment to the most problem-prone areas of the given geographic area. Color coding may be used to highlight road surfaces that should be avoided, or that require the most urgent attention from road maintenance staff in order to improve commuter safety. For multi-lane roads and highways, multiple color codes may be used on the same road to identify different road surface conditions across different lanes.

As the collected road surface information will age over time, in an embodiment, the mapped road surface condition data may be time stamped, and a data expiration mechanism may be set such that the road surface condition data may be replaced with more recent data collected from within a close vicinity of that point or the data may be removed from the map once the predetermined time has expired. This allows the road surface condition information to remain relatively current, and alert road maintenance staff to a need to send one or more vehicles to update road condition information over certain roads for which the road surface condition information has become too aged.

As shown in FIG. 1, a time slider interface may also be available to be used to plot the road surface condition information from a time other than the present time. This interface may be particularly useful in determining how the road conditions change over a period of time, for example before, during and after a snow storm.

The map may also be used to show road surface conditions on individual lanes in one or both directions. One possible graphical user interface that can be used to show road conditions in different lanes is by replacing the single road condition line in FIG. 1 by multiple parallel lines where each line depicts the road condition for a particular lane. Another variant could be to show multiple lanes only when the map is zoomed in or when the user clicks on a road segment or selects it using other methods like from a drop down menu.

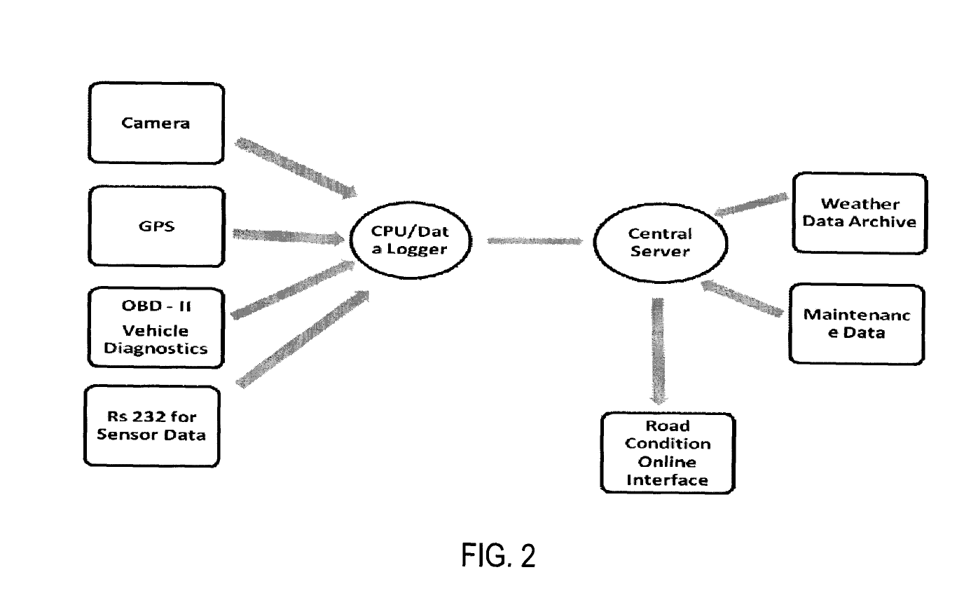

Now referring to FIG. 2, shown is an illustrative schematic block diagram of the system in accordance with an embodiment. As shown, the system includes a camera module, a GPS module, a vehicle diagnostics module, and an interface for sensor data. These modules interface with a CPU/Data Logger or data collection module. The collected data is communicated to a central server, which has access to a classification knowledge database including a weather data archive, and road maintenance data. In an embodiment, the system is programmed to store detailed maps and previously collected weather data for all roadways in the classification knowledge database. The system is also capable of communication between the data collection modules on various vehicles with the central server via wireless communications, including for example wireless Internet through a cellular network.

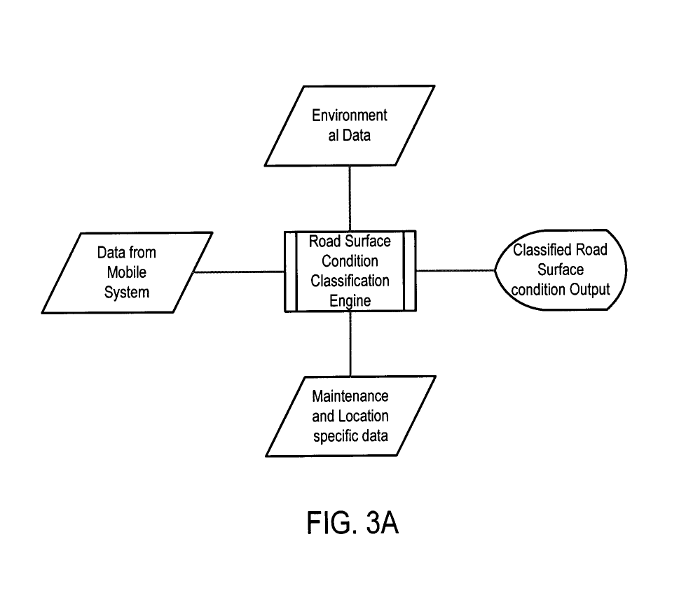

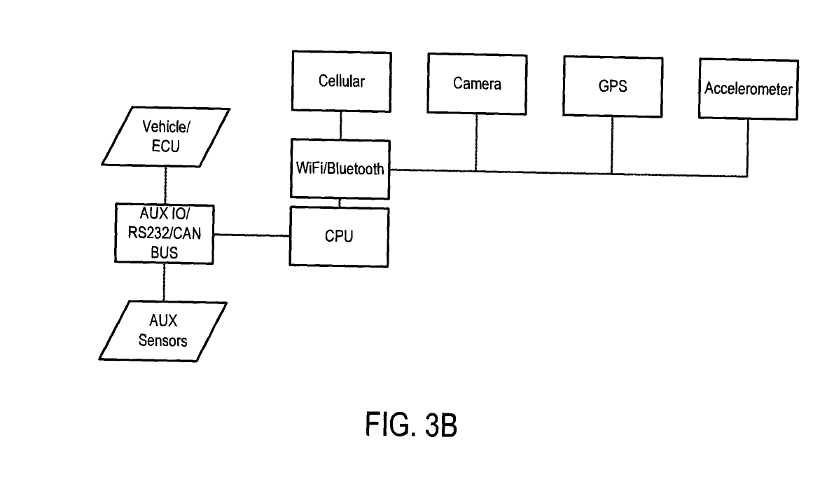

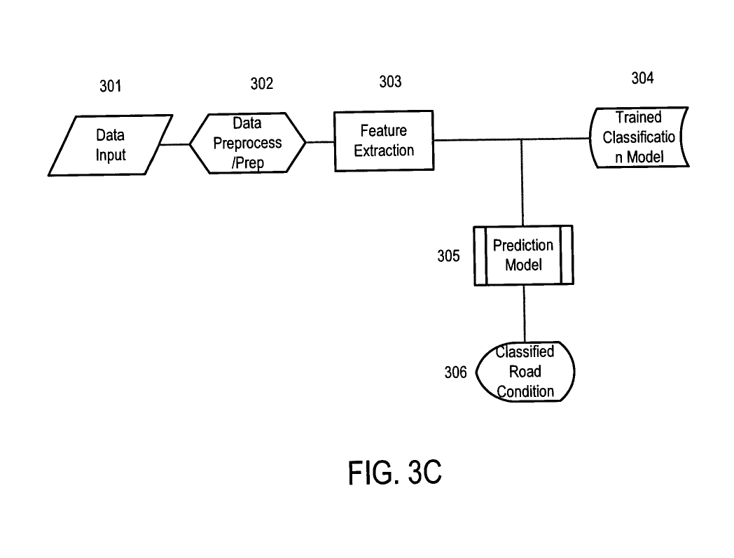

In another embodiment, as shown in FIG. 3A, the system may comprise a core CPU, RAM, ROM and other components necessary to execute software code, and which can be operatively connected to various vehicular sensors via an I/O interface. A range of data may be input via the I/O interface, including for example temperature sensor data, slat controllers, and data acquired from the vehicle's ECU.

In another embodiment, the data collection module includes Wi-Fi and Bluetooth capability to operatively connect and employ sensors, memory, computational power, etc. built into other devices, such as smart phones and tablets containing an on-board camera, accelerometer, and GPS module to provide video acquisition data, motion detection data, and GPS coordinates as inputs to the present system.

Furthermore, the system can carry out image processing, data processing and classification functions on the vehicular unit or smart phone, rather than transmitting all data to a central server to be processed. The required weather condition, maintenance and other data is still available on the server and the vehicular unit can request this information.

Still referring to FIG. 2, the central server is operatively connected to a road condition online interface accessible to a user, which provides an up-to-date status of road conditions in the geographic area based on the most recent data collected from the data collection modules in various vehicles. The central server is also programmed to communicate with the classification knowledge database including the weather data archive, and road maintenance data which provide supplemental information for road condition classification. This classification information may be downloaded to a classification module provided onboard each vehicle if the vehicle is so equipped to perform onboard road surface condition classification processing.

Now referring to FIG. 3A, shown is an illustrative schematic block diagram of a road surface condition classification engine and related components in accordance with an embodiment. As shown, the classification engine may have inputs from environmental data, maintenance and location specific data, and data collected from a mobile system, such as a smart phone or tablet for example. The classification engine has access to one or more previously trained models, one of which may be selected as the model that is most appropriate for a current data collection location. This can be based on the fact that a model that has been previously trained with location specific data unique to that site. Other criteria include model training data that is similar in terms of pavement type, topology ambient light and environmental conditions, etc. Based on classification processing, the road surface condition classification engine outputs a classified road surface condition, which may be communicated back to the central server of FIG. 2.

Now referring to FIG. 3B, shown is an illustrative schematic block diagram of a data collection module in accordance with an embodiment. As shown, the data collection module may include a CPU connected via an I/O bus to a vehicle's ECU, and to one or more auxiliary sensors which may provide input to the CPU.

In an embodiment, the data collection module includes Wi-Fi and Bluetooth capability to operatively connect and employ sensors built into other devices, such as cellular smart phones and tablets containing an on-board camera, GPS, and accelerometer modules to provide video acquisition data, GPS coordinates, and motion detection data as inputs to the CPU. As will be further explained, the various sensors from the mobile device, the vehicle ECU, and auxiliary vehicle sensors may all provide input to the CPU to help validate a road surface classification.

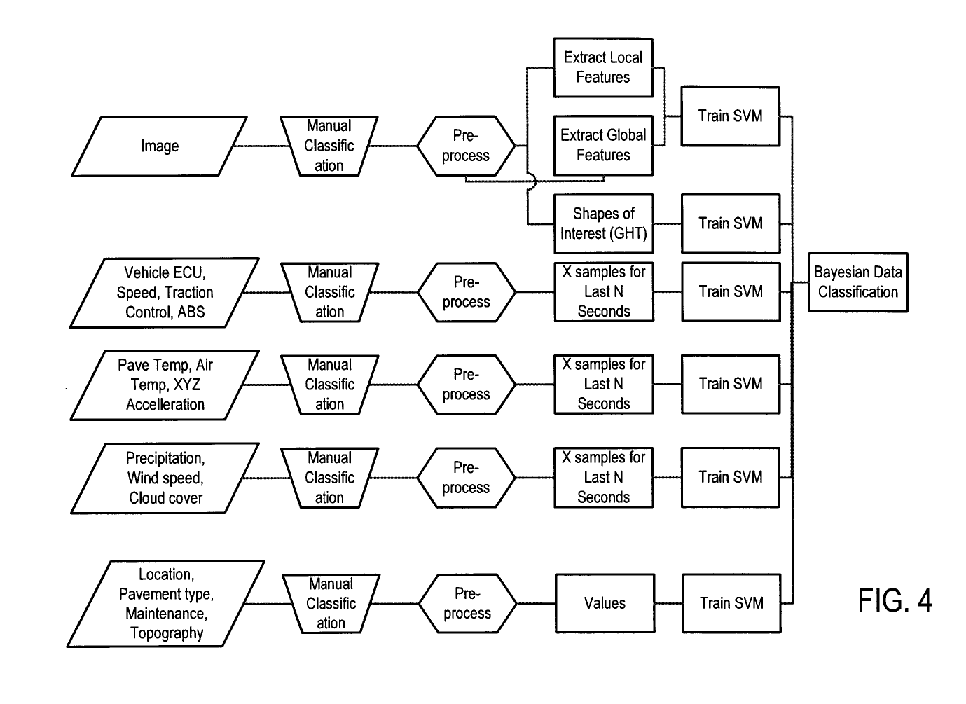

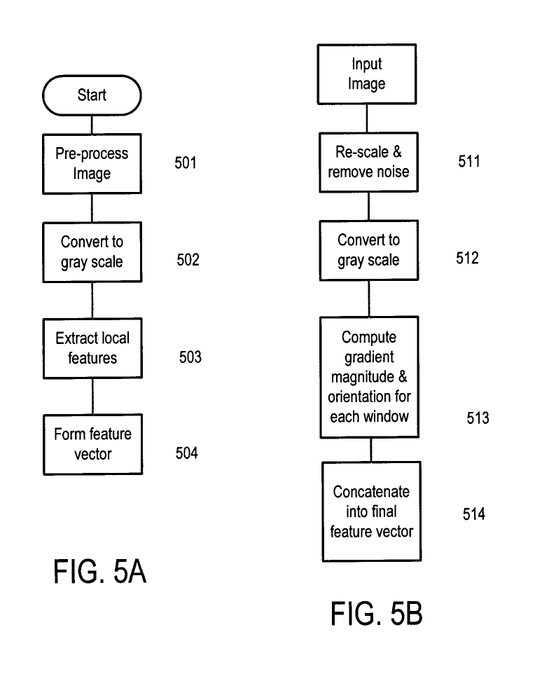

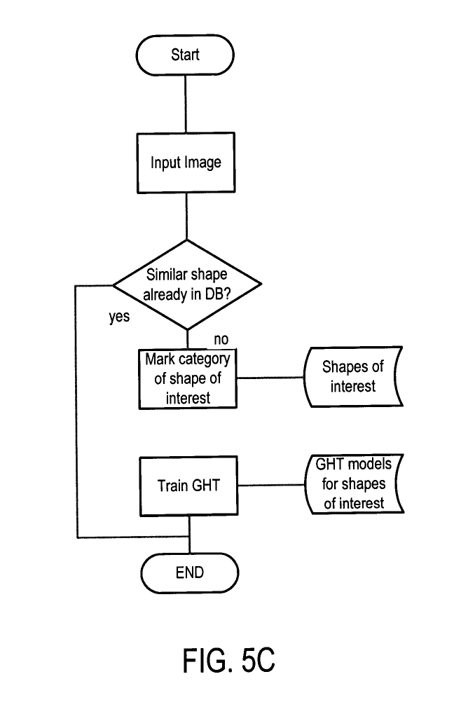

Now referring to FIG. 3C, shown is an illustrative schematic flow chart of road surface condition classification carried out on acquired road images and associated data collected using the data collection hardware described earlier. Data input 301 is received from the data collection unit illustrated in FIG. 3B as well as environmental and maintenance data illustrated in FIG. 3A. The data pre-processor at 302 conducts the necessary validation, noise removal, image cropping, resizing, and other preparation operations required to make the data suitable for feature extraction. For the purpose of illustration the example of an input image can be considered. The data pre-processor may analyze the size of the image file to determine its validity. For example, an image file with a zero or very small size may represent a camera malfunction. A size check may discard the image before it gets to the image classification process and result in a false classification. The data pre-processor may be implemented as software code being executed on a hardware platform. The feature extraction process 303 converts the input data into features suitable for the classification process and are explained in FIG. 4 and FIGS. 5A-5C. The features extracted in 303 are compared to an appropriate pre-trained classification model 304 (further discussed below) by a road surface prediction model 305 (further discussed below) to generate a road surface condition 306. The selection of an appropriate the classification model may be based on the location, environmental conditions and other variables. As an example, an appropriate model for a given road may be one that has been trained using data from the same or similar road sections. In another situation where a locally trained model is not available, an appropriate choice of model would be the one that has been trained using pavement that has similar asphalt color and material as the current area. The variety of models may be stored locally within the classification system or may have to be fetched from a central server. Detail of the feature vector creation process, model training and classification can be found in the following sections.

Now referring to FIG. 4, shown is a schematic flow diagram of a classification model training process in accordance with an exemplary embodiment. In an embodiment, the classification model uses training data from a number of different sources including data from the data collection unit. In addition, the classification training model uses archived or live data from weather sources as well as maintenance and pavement condition databases that could be maintained by authorities or maintenance service providers of the area.

In particular, FIG. 4 refers to image data, pavement/air temperature data, GPS location data, ABS status data, vehicle speed, acceleration data where some or all of which may be collected using a data collection unit. FIG. 4 also refers to other data that is important for robust classification of road condition information, including road maintenance data, current and previous precipitation data(amount and type), weather data (temperature, humidity, cloud cover), pavement and topography data including presence of snow fences/trees, color and material of pavement, number of lanes and type of lane markings.

FIG. 4 further illustrates the general model learning and training process where each data item is first preprocessed to remove noise and to perform initial resizing if needed. Then, the data points are in many cases manually classified in order to train a classification model that can then be used for automated road surface condition classification. Data from all different sources is classified according to one of many road surface conditions as seen in the corresponding image. To fully classify a road surface condition, it is assessed in terms of the contaminant present on the road as well as the coverage of the contaminant. The list of contaminants that can be found include but is not limited to bare wet, bare dry, loose snow, packed snow, slush, ice, bonded snow. The coverage can include fully covered, bare, center covered right track bare, center covered left track bare, center covered both tracks bare, and drifting snow. Road surface on a lane can be described as any combination of contaminant and coverage from the above lists. As an example, road condition can be snow covered (contaminant) in the center and both tracks bare (coverage) or fully covered (coverage) with slush (contaminant) etc.

This data is then used to generate individual feature vectors for each image of a road surface being classified. Feature-wise models are trained using a supervised learning technique such as Support Vector Machines (SVM). For example, image features may be treated separately from weather features and so on. Combination of the outcomes of all individual models is then used to train a second model that performs an overall road condition estimate that is not based on individual features but a combination of all. Feature vector creation is covered in detail in the following sections.

Still referring to FIG. 4 that illustrates other inputs/data like ABS, Traction Control and Speed, air temperature, pavement temperature, xyz acceleration, precipitation, wind speed (and others) values from a variety of sources that are used to enhance the road surface classification. In an embodiment, the status of the data is sampled at a rate of X samples per minute, for Y seconds before and after the time the actual image was taken. Where X and Y are arbitrary numbers that may vary for the different types of data. As an example, the status of the ABS may be sampled every second for the 5 seconds before and after the acquisition of the image. An SVM is trained for each data type and the corresponding road surface condition.

In order to combine the output from each of the different classification models based on different sources of data, a Bayesian data classification model is trained with input consisting of results from the above trained SVM along with location, topography, pavement type and maintenance information.

The result is a classification system that not only relies on global or local image features but a large number of other data sources to classify road surface conditions. As an example, the image of a road scene with shiny glare from the sun may look like a snow covered road and hence be false classified if an image only classification method was used. However, using the above approach, high pavement temperature, no snowfall in previous days, recent salting and plowing (maintenance actions) etc can be used to correct this classification that otherwise would have been false. In a similar fashion, an image based detection of drifting snow can be further strengthened by high wind and recent snowfall along with absence of trees and snow fences. As another example, an image based classification of snow covered can be validated if there are no road signs detected in the image.

In an embodiment, image data is used to extract at least three different types of features including local features, global features and presence of shapes of interest. Now refereeing to FIG. 5A, shown is an illustrative method in accordance with an embodiment, which explains the extraction of local image features for model training. The image is first optionally preprocessed to perform any cropping, resizing or noise removal at step 501, and the resulting image is optionally converted to gray scale at step 502. Local features are then extracted at 503 using a version of a Scale Invariant Feature Transformation (SIFT) technique, for example as described in Distinctive Image Features from Scale-Invariant Keypoints, by David G. Lowe, published in the INTERNATIONAL JOURNAL OF COMPUTER VISION 60(2), 91-110 (2004), which is incorporated herein by reference in its entirety. However, other feature detection techniques are possible such as, for example, contour based methods, intensity based methods and parametric model based methods, to name a few. A feature vector is then formed at 504.

Similarly, FIG. 5B illustrates the computation of global features using a Histogram of Oriented Gradients approach. The input image is first optionally preprocessed to perform any cropping, resizing or noise removal at step 511, and the resulting image is optionally converted to gray scale at step 512. A gradient magnitude and orientation are then computed for an arbitrary window at step 513, using sizes such as 16×16 or 64×64, for example. For gradient computation, a variety of mask types and sizes can be used. As an example [−1,0,1] and [−1,0,1]^{T} could be used to computer x and y gradient. Gradient magnitude and direction can be calculated using formulas

Magnitude s=(sₓ²+s_{y}²)^{1/2}

Direction θ=arctan(s_{y}/sₓ)

Gradient direction can be quantized into a total for 4 bins of 90 degrees. A histogram of gradient magnitude of each bin can then be formed for each window. The final feature vector can be formed by concatenating all histograms at step 514.

A supervised learning method such as the SVM (support vector machine) can be used in a one against all configuration to train models for the local and global features described above.

Now referring to FIG. 5C, in an embodiment, Generalized Hough Transform detectors may be trained for all different type of pavement markings that can be found in different images. The Generalized Hough Transform (GHT) as described in “Generalizing the Hough Transform to Detect Arbitrary Shapes,” by D. H. Ballard, published in Pattern Recognition, Vol. 13, No. 2 (1981), pp. 111-122, describes a generalized Hough transform algorithm capable of extracting graphics of any shape. The Hough transform is a straight line detection algorithm, which was first proposed by P. V. C. Hough (U.S. Pat. No. 3,069,554) and later improved by R. O. Duda and P. E. Hart (R. O. Duda and P. E. Hart, “Use of the Hough Transform to Detect Lines and Curves in Pictures,” Communications of the ACM, Vol. 15, No. 1, pp. 11-15, 1972) and are incorporated herein by reference in its entirety. During the training process as images are reviewed manually, whenever a new shape of interest is visually seen on the pavement including but not limited to zebra crossing, broken lane marking, solid lane marking, turning right, turning left, etc., it is compared to the existing set of shapes in the GHT training data. If no similar shape is found at the decision box, then a GHT model is added to the existing shapes of interest models. As an example, a particular area may have two geometrically different kinds of left turn makers. Then, the set of GHT models for left turn markers may contain two or more trained models that will be able to detect this left turn marker. More models will be added to this list till all variations of this shape have been covered.

The presence (denoted by 1) and absence (denoted by 0) for at least one shape belonging to each of the classes can be combined to generate a shapes of interest feature vector. For example, if the system has three classes of shapes namely, side marking, center marking and crossing where each class could have multiple GHT models covering the same in its different forms and only one side marking has been found to exist, while center marking and crossing could not be detected by any of the GHT models, the end feature vector will look like [1,0,0].

Now referring to the final step of data classification model training in FIG. 4 where results from individual SVMs are combined to train an overall classification model that uses results from image based classification models as well as classification models based on environmental, topographical and maintenance data.

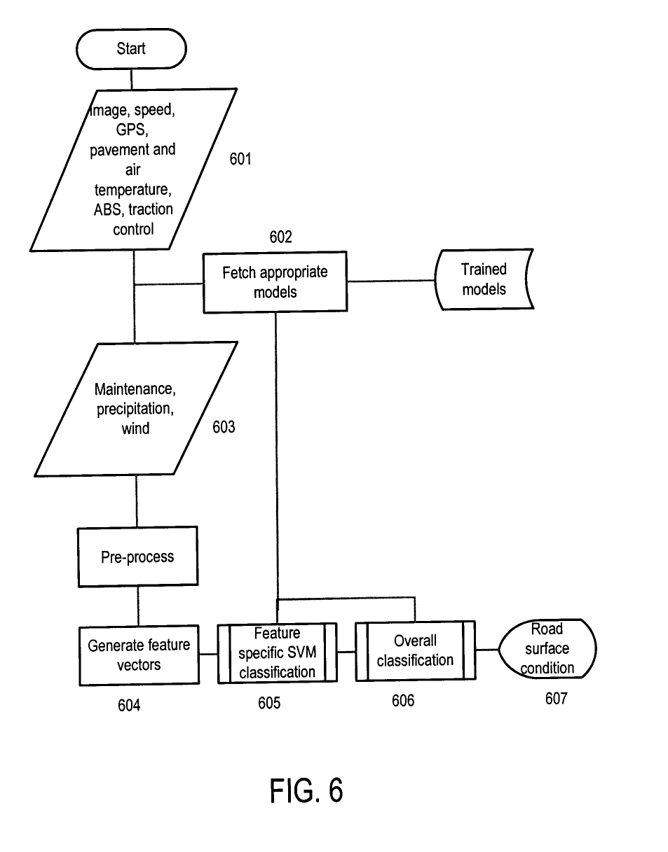

Now referring to FIG. 6 that illustrates the overall real-time image classification process. Section 601 refers to the data collected from a mobile or stationary data collection unit described earlier. The location and other information from 601 may be used to fetch an appropriate model from a number of existing models that have been trained with different data sets. The process in 602 may include selecting the most appropriate model based on location, pavement color and other environmental variables. For example, selection criteria for the best appropriate model can be based on the fact that a model that has been previously trained with location specific data unique to that site. Other criteria include model training data that is similar in terms of pavement type, topology ambient light and environmental conditions, etc. The same classification model can also be used for data within a given geographical region and hence finding the most optimal classification model for every data that comes in may not be necessary. Processed D, E, F and G in FIG. 6 have already been explained earlier in the document.

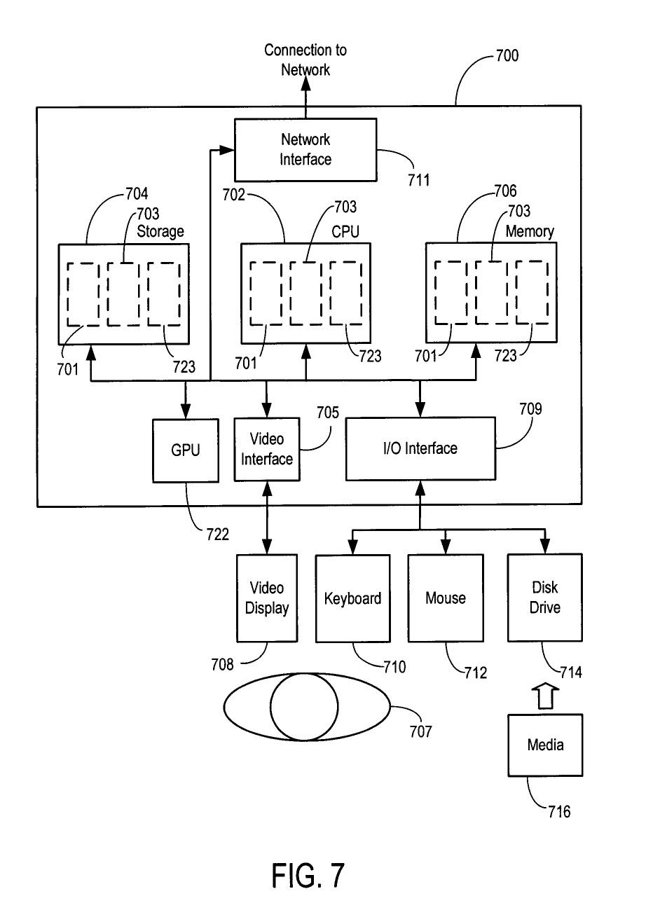

Now referring to FIG. 7 the present system and method may be practiced in various embodiments. A suitably configured generic computer device, and associated communications networks, devices, software and firmware may provide a platform for enabling one or more embodiments as described above. By way of example, FIG. 7 shows a generic computer device 700 that may include a central processing unit (“CPU”) 702 connected to a storage unit 704 and to a random access memory 706. The CPU 702 may process an operating system 701, application program 703, and data 723. The operating system 701, application program 703, and data 723 may be stored in storage unit 704 and loaded into memory 706, as may be required. Computer device 700 may further include a graphics processing unit (GPU) 722 which is operatively connected to CPU 702 and to memory 706 to offload intensive image processing calculations from CPU 702 and run these calculations in parallel with CPU 702. An operator 707 may interact with the computer device 700 using a video display 708 connected by a video interface 705, and various input/output devices such as a keyboard 710, mouse 712, and disk drive or solid state drive 714 connected by an I/O interface 709. In known manner, the mouse 712 may be configured to control movement of a cursor in the video display 708, and to operate various graphical user interface (GUI) controls appearing in the video display 708 with a mouse button. The disk drive or solid state drive 714 may be configured to accept computer readable media 716. The computer device 700 may form part of a network via a network interface 711, allowing the computer device 700 to communicate through wired or wireless communications with other suitably configured data processing systems (not shown). The generic computer device 700 may be embodied in various form factors including desktop and laptop computers, and wireless mobile computer devices such as tablets, smart phones and super phones operating on various operating systems. It will be appreciated that the present description does not limit the size or form factor of the computing device on which the present system and method may be embodied.

Thus, in an aspect, there is provided a computer implemented method for classifying winter road surface conditions, comprising: acquiring a digital image of a road surface at a given location and time; processing the acquired digital image to generate one or more feature vectors for classifying winter road surface conditions; acquiring values for auxiliary data to create feature vectors that enhance classification of the winter road surface conditions; and based on a comparison of the feature vectors to models in a classification knowledge database, classifying the road surface condition at the given location and time of the acquired digital image.

In an embodiment, the method further comprises: collecting classified road surface condition information acquired from a plurality of vehicles travelling over one or more roads; and mapping the classified winter road surface conditions for the one or more roads on a graphical display of a geographic region.

In another embodiment, the method further comprises: classifying the winter road surface condition type based on the amount and coverage pattern of one or more of snow, ice and slush etc.

In another embodiment, the winter road surface condition type is classified as a combination of contaminants and their coverage. Contaminants include loose snow, drifting snow, ice, slush, packed snow etc, whereas coverage may also include a range, such as fully covered, center covered track bare, one track bare, patches etc.

In another embodiment, the method further comprises mapping the winter road surface condition by color based on the classified winter road condition type.

In another embodiment, the method further comprises mapping the winter road surface conditions by color based on the classified winter road condition type for each lane of a multi-lane road or highway.

In another embodiment, the method further comprises time stamping the mapped winter road surface condition data, and providing a time slider interface for displaying the road surface condition data at different times to appear on the map.

In another embodiment, the method further comprises acquiring various environmental parameters; and processing the acquired environmental parameters to create feature vectors to enhance the classification of the road surface condition at a given time.

In another embodiment, the method further comprises: acquiring various topographical parameters; and processing the acquired topographical parameters to create feature vectors to enhance the classification of the road surface condition at a given road location.

In another embodiment, the method further comprises: acquiring vehicle operating parameters; and processing the vehicle operating parameters to create feature vectors to enhance the classification of the road surface condition at a given road location.

In another embodiment, the method further comprises: acquiring vehicle sensor parameters; and processing the vehicle sensor parameters to create feature vectors to enhance the classification of the road surface condition at a given road location.

In another embodiment, the method further comprises recommending a winter road maintenance procedure based on the classified winter road surface condition type.

In another aspect, there is provided a system for classifying winter road surface conditions, wherein the system is adapted to: acquire a digital image of a road surface at a given location and time; process the acquired digital image to generate one or more feature vectors for classifying winter road surface conditions; acquire values for auxiliary data to create feature vectors that enhance classification of the winter road surface conditions; and classify the road surface condition at the given location and time of the acquired digital image based on a comparison of the feature vectors to models in a classification knowledge database.

In an embodiment, the system is further adapted to: collect classified road surface condition information acquired from a plurality of vehicles travelling over one or more roads; and map the classified winter road surface conditions for the one or more roads on a graphical display of a geographic region.

In another embodiment, the system is further adapted to: classify the winter road surface condition type based on the amount and coverage pattern of one or more of snow, ice and slush.

In another embodiment, the winter road surface condition type is classified as one or more of snow covered, loose snow, packed snow, bonded snow, drifting snow, center covered track bare with snow, ice covered, slush covered, center covered track bare with slush, bare wet, bare dry, and fully bare, etc.

In another embodiment, the system is further adapted to map the winter road surface condition by color based on the classified winter road condition type.

In another embodiment, the system is further adapted to map the winter road surface conditions by color based on the classified winter road condition type for each lane of a multi-lane road or highway.

In another embodiment, the system is further adapted to time stamp the mapped winter road surface condition data, and provide a time slider interface for displaying the road surface condition data at different times to appear on the map.

In another embodiment, the system is further adapted to: acquire various environmental parameters; and process the acquired environmental parameters to create feature vectors to enhance the classification of the road surface condition at a given time.

In another embodiment, the system is further adapted to: acquire various topographical parameters; and process the acquired topographical parameters to create feature vectors to enhance the classification of the road surface condition at a given road location.

In another embodiment, the system is further adapted to: acquire vehicle operating parameters; and process the vehicle operating parameters to create feature vectors to enhance the classification of the road surface condition at a given road location.

In another embodiment, the system is further adapted to: acquire vehicle sensor parameters; and process the vehicle sensor parameters to create feature vectors to enhance the classification of the road surface condition at a given road location.

In another embodiment, the system is further adapted to recommend a winter road maintenance procedure based on the classified winter road surface condition type.

Thus, in an aspect, there is provided a method of classifying road surface conditions, comprising: capturing digital images of a road traveled by a vehicle; acquiring values for various environmental and vehicle parameters corresponding to the time and location of the captured digital images; analyzing the captured digital images and the environmental and vehicle parameters to generate a plurality of feature vectors; and based on a comparison of the feature vectors to models in a classification knowledge database, classifying the road surface conditions at the locations and times of the captured digital images.

In another aspect, there is provided a system for classifying road surface conditions, the system adapted to: capture digital images of a road traveled by a vehicle; acquire values for various environmental and vehicle parameters corresponding to the time and location of the captured digital images; analyze the captured digital images and the environmental and vehicle parameters to generate a plurality of feature vectors; and based on a comparison of the feature vectors to models in a classification knowledge database, classify the road surface conditions at the locations and times of the captured digital images.

In another aspect, there is provided a method of classifying winter road surface conditions, comprising: capturing digital images of a road traveled by a moving vehicle or a stationary camera; acquiring values for various environmental and vehicle parameters corresponding to the time and location of the captured digital images; analyzing the captured digital images and the environmental and vehicle parameters in combination with maintenance data and other location specific information either previously collected or made available from other sources to generate a plurality of feature vectors; and based on a comparison of the feature vectors to models in a classification knowledge database, classifying the road surface conditions at the locations and times of the captured digital images, and reporting the classified road surface conditions to a central station to initiate and control road maintenance procedures.

In another embodiment, the method and system analyzes digital images captured by an image capturing device mounted on a vehicle or at a stationary location to determine the road surface conditions based on the analysis of the images and based on values for various parameters acquired from available information sources and environmental sensors.

In another embodiment, the method and system may acquire historical weather data as well as weather forecast information from a local weather office which provides an up-to-date weather forecast and acquire other measurements of environmental conditions using various sensors. For example, the environmental conditions acquired may include air temperature, pavement temperature, amount of precipitation in previous hours, the wind speed, amount of cloud cover, and so on. The method and system may also acquire up-to-date information on road maintenance including snow removal and salting/sanding that has been recently performed within a specified time period.

In another embodiment, the method and system includes an apparatus adapted to be installable on a vehicle or a stationary location like an electric pole, and which captures digital images of the road surface using a light sensitive array, for example as provided in a digital camera. The digital camera is connected to a data collection module to store the captured data. The data collection module may employ a purpose built computer system adapted to execute software code written to store the captured digital images along with other data obtained from various sources.

While illustrative embodiments of the invention have been described above, it will be appreciate that various changes and modifications may be made without departing from the scope of the present invention.

1. A computer implemented method for classifying winter road surface conditions, comprising:
acquiring a digital image of a road surface at a given location and time;
processing the acquired digital image to generate one or more feature vectors for classifying winter road surface conditions;
acquiring values for auxiliary data to create feature vectors that enhance classification of the winter road surface conditions; and
based on a comparison of the feature vectors to models in a classification knowledge database, classifying the road surface condition at the given location and time of the acquired digital image.

2. The method of claim 1, further comprising:
collecting and classifying road surface condition information acquired from a plurality of vehicles travelling over one or more roads; and
mapping the classified winter road surface conditions for the one or more roads on a graphical display of a geographic region.

3. The method of claim 2, further comprising:
classifying the winter road surface condition type based on the amount and coverage pattern of one or more of snow, ice and slush.

4. The method of claim 3, wherein the winter road surface condition type is classified as one or more of snow covered, loose snow, packed snow, bonded snow, drifting snow, center covered track bare with snow, ice covered, slush covered, center covered track bare with slush, bare wet, bare dry.

5. The method of claim 4, further comprising mapping the winter road surface condition by color based on the classified winter road condition type.

6. The method of claim 5, further comprising mapping the winter road surface conditions by color based on the classified winter road condition type for each lane of a multi-lane road or highway.

7. The method of claim 6, further comprising time stamping the mapped winter road surface condition data, and providing a time slider interface for displaying the road surface condition data at different times to appear on the map.

8. The method of claim 4, further comprising recommending a winter road maintenance procedure based on the classified winter road surface condition type.

9. The method of claim 1, further comprising:
acquiring various environmental parameters; and
processing the acquired environmental parameters to create feature vectors to enhance the classification of the road surface condition at a given time.

10. The method of claim 1, further comprising:
acquiring various topographical parameters; and
processing the acquired topographical parameters to create feature vectors to enhance the classification of the road surface condition at a given road location.

11. The method of claim 1, further comprising:
acquiring vehicle operating parameters; and
processing the vehicle operating parameters to create feature vectors to enhance the classification of the road surface condition at a given road location.

12. The method of claim 1, further comprising:
acquiring vehicle sensor parameters; and
processing the vehicle sensor parameters to create feature vectors to enhance the classification of the road surface condition at a given road location.

13. A system for classifying winter road surface conditions, wherein the system is adapted to:
acquire a digital image of a road surface at a given location and time;
process the acquired digital image to generate one or more feature vectors for classifying winter road surface conditions;
acquire values for auxiliary data to create feature vectors that enhance classification of the winter road surface conditions; and
classify the road surface condition at the given location and time of the acquired digital image based on a comparison of the feature vectors to models in a classification knowledge database.

14. The system of claim 13, wherein the system is further adapted to:
collect classified road surface condition information acquired from a plurality of vehicles travelling over one or more roads; and
map the classified winter road surface conditions for the one or more roads on a graphical display of a geographic region.

15. The system of claim 14, wherein the system is further adapted to:
classify the winter road surface condition type based on the amount and coverage pattern of one or more of snow, ice and slush.

16. The system of claim 15, wherein the winter road surface condition type is classified as one or more of snow covered, loose snow, packed snow, bonded snow, drifting snow, center covered track bare with snow, ice covered, slush covered, center covered track bare with slush, bare wet, bare dry, and fully bare.

17. The system of claim 16, wherein the system is further adapted to map the winter road surface condition by color based on the classified winter road condition type.

18. The system of claim 17, wherein the system is further adapted to map the winter road surface conditions by color based on the classified winter road condition type for each lane of a multi-lane road or highway.

19. The system of claim 18, wherein the system is further adapted to time stamp the mapped winter road surface condition data, and provide a time slider interface for displaying the road surface condition data at different times to appear on the map.

20. The system of claim 13, wherein the system is further adapted to:
acquire various environmental parameters; and
process the acquired environmental parameters to create feature vectors to enhance the classification of the road surface condition at a given time.

21. The system of claim 13, wherein the system is further adapted to:
acquire various topographical parameters; and
process the acquired topographical parameters to create feature vectors to enhance the classification of the road surface condition at a given road location.

22. The system of claim 13, wherein the system is further adapted to:
acquire vehicle operating parameters; and
process the vehicle operating parameters to create feature vectors to enhance the classification of the road surface condition at a given road location.

23. The system of claim 13, wherein the system is further adapted to:
acquire vehicle sensor parameters; and
process the vehicle sensor parameters to create feature vectors to enhance the classification of the road surface condition at a given road location.

24. The system of claim 13, wherein the system is further adapted to recommend a winter road maintenance procedure based on the classified winter road surface condition type.
